(19) United States
(12) Patent Application Publication
(10) Pub. No.: US 2008/0018653 A1
(43) Pub. Date: Jan. 24, 2008

(54) GRAPHIC CARD

(75) Inventor: Ta-Wei Liu, Taipei City (TW)

Correspondence Address: J C PATENTS, INC., 4 VENTURE, SUITE 250, IRVINE, CA, 92618, US

(73) Assignee: ELITEGROUP COMPUTER SYSTEMS CO.,LTD, Taipei (TW)

(21) Appl. No.: 11/459,410

(22) Filed: Jul. 24, 2006

(51) Int. Cl. G06F 13/14

(52) U.S. Cl. 345/520

(57) ABSTRACT

A graphic card includes a graphic chip, an output port and a transforming apparatus. The graphic chip outputs an image signal. The transforming apparatus receives the image signal and an audio signal provided by an external source and integrates them into a video signal. And then the transforming apparatus transmits the video signal to the output port.

### BACKGROUND OF THE INVENTION

1. Field of the Invention

The present invention is relates to a graphic card and more particularly to a graphic card capable of outputting video signals.

2. Description of the Related Art

Recently, high definition television is getting replacing traditional analog television to satisfy needs of more and more complex and variety of function and video signal standard. A novel high definition television includes many input terminals. Conventional signal input/output terminals comprise Digital Visual Interface (hereafter called DVI), Composite, High Definition Multimedia Interface (hereafter called HDMI) and so forth.

Wherein, DVI recently has become the most successful digital interface of liquid crystal monitor and notebook computer. Although it is focused on personal computer (i.e. PC) market, in the beginning, DVI also reasonably enter into field of consumer electronics because of adoption of plasma television. Different from DVI which suits for use in the PC monitor, HDMI is developed from DVI that suits for use in the digital house electric appliance such as digital television, digital video disc (i.e. DVD) player, set-top box and other digital audio-visual products. HDMI can transmit high definition video and multi-channel audio signal without compression in the requirement of keeping high definition and high vividness. Besides, HDMI interface can also provide data transmission bandwidth of 5 Gbps.

The advantages of HDMI application are that video signals can be transmitted simultaneously by merely a HDMI transmission line that saves more lines connection. From consumer point of view, HDMI not only provides clear picture quality but also simplifies installation of home theater system because of same cable that are adopted by audio and video. Except different package process, HDMI pins are compatible with DVI pins. HDMI can transmit digital audio signal when comparing with DVI. A characteristic of HDMI installation is “plug-and-play”, automatic “consultation” between signal source and display equipment. It automatically proceeds to choose the most suitable video/audio format. In addition to the image data, HDMI can even transmit eight audio channel signals simultaneously. HDMI can transmit high definition video signal and multi-channels audio signal simultaneously by smaller connector that is easier to use and reduce usage of conductive line. This meets enterprise's expectation in consumer electronic products.

It is a trend that the personal computers is gradually integrated in the household electric appliance. However in the view of graphic card of personal computer, because conventional graphic card can only support image output, it's an important issue to solve for a personal computer being a household electric appliance about how to output video signals in a graphic card simultaneously so as to support new video interface such as HDMI.

### SUMMARY OF THE INVENTION

The purpose of the present invention is to provide a graphic card that able to integrate image signal and audio signal into a video signal output so as to match new generation interface standard to get display picture and image of high quality.

Based on above and other purposes, the present invention provides a graphic card including a display chip, an output port and a transforming apparatus. The graphic chip is used to output image signals. The output port is use to connect external apparatus. And the transforming apparatus is use to receive image signal and audio signal and integrate into a video signal for transmitting to the output port.

The graphic card according to preferred embodiment of the present invention that described above includes a connector connected to the transforming apparatus so as to receive audio signal.

The graphic card according to preferred embodiment of the present invention, above described audio signal is provided by a motherboard, and the audio signal is transmitted from the motherboard through the connector to the transforming apparatus.

According to another preferred embodiment of the present invention, above described audio signal is provided by a sound card, and the audio signal is transmitted from the sound card through the connector to the transforming apparatus.

In the present invention, the graphic card can integrate the image signal and the audio signal into a video signal and output simultaneously so as not only to support new video interface such as HDMI to get display picture and image of higher quality but also to reduce usage of signal transmission line.

To enables above and other purposes, characteristics and advantages of the present invention easily and obviously understood, following description with preferred embodiments and accompanying figures will be described in detail.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram schematically shows a graphic card, according to a preferred embodiment of the present invention.

FIG. 2 is a diagram schematically shows the graphic card, according to another preferred embodiment of the present invention.

### DESCRIPTION OF THE PREFERRED EMBODIMENTS

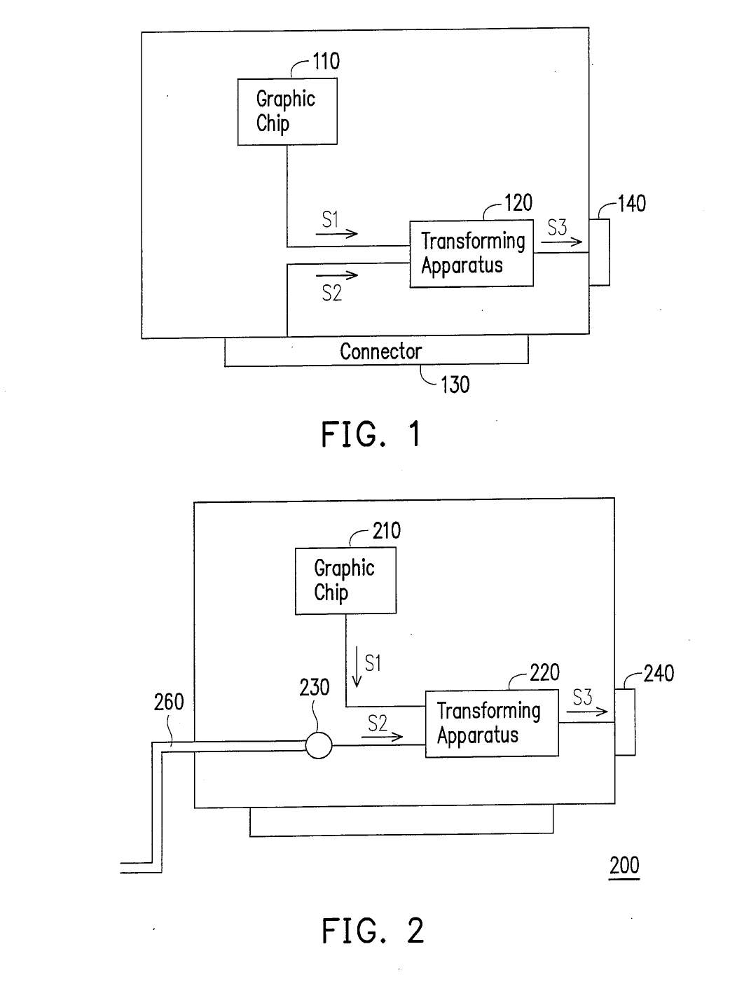

FIG. 1 is a diagram schematically shows a graphic card, according to a preferred embodiment of the present invention. The graphic card 100 includes a graphic chip 10, a transforming apparatus 120, a connector 130 and an output port 140. The connector 130 in the present invention can be a general gold finger, inserting the gold finger into an interface socket of a motherboard (not shown) so as to electrically connect to the motherboard. The motherboard defines many interface sockets to expand its insufficient function by insertion of different function interface card. Usual interfaces in the personal computer include Industry Standard Architecture (called ISA), Peripheral Component Interconnect (called PCI) and Accelerated Graphics Port (called AGP). The interfaces can basically be identified by the gold finger on the interface card.

New generation interface appeared in the present use is Peripheral Component Interconnect Express (called PCI Express). The so-called PCI Express bus standard is the next PCI generation product that provides higher efficiency, flexibility and expandability to new generation system and keeps software compatibility with current PCI application programs. In comparing with the conventional PCI interface, PCI Express is a high speed bus interface of 250 MB/S transmission bandwidth that is two times of the transmission speed (133 MB/S) of conventional PCI interface. PCI Express is not just used in display transmission like AGP interface, as done by the AGP interface. The PCI Express can further be used in sound card, Ethernet adaptor and image captured card for transmission. Besides, PCI Express can also be applied to a full duplex mode which is similar to dual channel memory technology. In such mode, bandwidth of data transmission speed will get twice of normal condition. PCI Express standard includes many standards such as x1, x2, x4, x8, x16, x32 and so on. Socket length of each standard is different, the larger number gets the longer socket length that can be observed from their appearance. In the present embodiment, the connector 130 of the graphic card 100 matches PCI Express bus standard, but the present invention can also suit for use in other bus standards except the exampled standard.

Referring to FIG. 1, the connector 130 is coupled to the transforming apparatus 120. The connector 130 is electrically connected to the motherboard (not shown) to provide an audio signal S2. The graphic chip 110 outputs an image signal S1 to the transforming apparatus 120. Pin numbers of the connector 130 demands more than that demanded by the PCI Express bus standard, the audio signal S2 can be transmitted from the motherboard through the connector 130 to the transforming apparatus 120 by the pins that are not used by the PCI Express bus. The transforming apparatus 120 integrates the received image signal S1 and the audio signal S2 into a video signal S3 and then transmits the video signal S3 to the output port 140. The video signal S3 of the present embodiment is a high definition multimedia interface signal, the connector 130 matches the PCI bus standard and the output port 140 is a high definition multimedia interface. When connecting the output port 140 to an external device that also owns high definition multimedia interface (such as digital television, DVD recorder and so on, not shown), the effect of high definition and high vividness can be achieved by using HDMI to transmit image signals of high picture quality and multi-channel audio signals without compression. Since the graphic chip 10 of the graphic card 100 only provides image signal and is unable to provide audio signal, the audio signal S2 must be transmitted from the motherboard through the connector 130 to the graphic card 100. The motherboard of the present embodiment is also designed in accordance with the graphic card 100 so as to transmit the audio signal to the connector 130.

FIG. 2 is a diagram schematic shows the graphic card, according to another preferred embodiment of the present invention. The graphic card 20 includes a graphic chip 210, a transforming apparatus 220, a connector 230, an output port 240 and a transmission line 260. Wherein, the connector 230 is coupled to the transforming apparatus 220. The image signal Si is outputted from the graphic chip 210 to the transforming apparatus 220. Because the motherboard of the present invention doesn't provide relevant design in accordance with the graphic card 200, the audio signal S2 provided by the motherboard will be transmitted through the transmission line 260, which is interconnected with the connector 230, to the transforming apparatus 220. Besides, the audio signal S2 can be provided by a sound card (not shown) and also transmitted through the transmission line 260, which is interconnected with the connector 230, to the transforming apparatus 220. The image signal S1 is outputted from the graphic chip 210 to the transforming apparatus 220. The image signal S1 and the audio signal S2 will be integrated into a video signal S3 and transmitted to the output port 240 after the transforming apparatus 200 receives the image signal S1 and the audio signal S2. The video signal S3 is a high definition multimedia interface signal and the output port 240 is a high definition multimedia interface. When the output port 240 is connected to an external device (not shown) with high definition multimedia interface, effect of high definition and high vividness will be got by using HDMI to transmit image signal of high quality and multi-channel audio signal simultaneously. The connector 230 of the present embodiment is matched to Sony-Philips Digital Interface (called SPDIF interface). In the earliest promotion, SPDIF is used for increasing digital audio signal transmission, its highest definition is 24 bytes, the preciseness and simultaneousness of data of high speed transmission medium such as optical fiber will be ensured furthermore. The SPDIF is basically used in transmission of music digital signal.

As described above, advantages of the present invention are that the graphic card can transmit audio and image signal simultaneously to meet new generation video interface standard (for ex, HDMI) so as to increase display picture quality and audio quality and reduce usage of signal transmission lines.

It will be further understood that various changes in the details, materials, and arrangements of the parts which have been described and illustrated in order to explain the nature of this invention may be made by those skilled in the art without departing from the principle and scope of the invention as expressed in the following claims. Although the steps in the following method claims, if any, are recited in a particular sequence with corresponding labeling, unless the claim recitations otherwise imply a particular sequence for implementing some or all of those steps, those steps are not necessarily intended to be limited to being implemented in that particular sequence.

What is claimed is:

1. A graphic card, includes:
a graphic chip, used for outputting an image signal,
a output port, used to connect to an external device, and
a transforming apparatus, used to receive the image signal and an audio signal and integrate the two signals into a video signal for transmitting to the output port.

2. A graphic card according to claim 1, wherein the output port is a high definition multimedia interface and the video signal is a high definition multimedia interface signal.

3. A graphic card according to claim 1, further comprising:
a connector coupled to the transforming apparatus to receive the audio signal.

4. A graphic card according to claim 3, wherein the connector is adapted in the PCI bus standard.

5. A graphic card according to claim 4, wherein the audio signal is provided by a motherboard and transmitted from the motherboard through the connector to the transforming apparatus.

6. A graphic card according to claim 5, wherein the audio signal is transmitted by pins of the connector, not being used by the unused PCI bus standard, to the transforming apparatus.

7. A graphic card according to claim 3, wherein the connector is suitable for sue in SPDIF digital interface.

8. A graphic card according to claim 7, wherein the audio signal is provided by a motherboard and transmitted from the motherboard through the connector to the transforming apparatus.

9. A graphic card according to claim 7, wherein the audio signal is provided by a sound card and transmitted from the sound card through the connector to the transforming apparatus.

10. A graphic card according to claim 3, wherein the audio signal is transmitted to the connector through a transmission line.
